(19) United States
(12) Patent Application Publication
(10) Pub. No.: US 2007/0273883 A1
(43) Pub. Date: Nov. 29, 2007

(54) Sensor Arrangement

(75) Inventors: Stefan Dickopf, Heidelberg (DE); Klaus Burkert, Heidelberg (DE); Alexander Maier, Mosbach (DE); Kristina Schmidt, Schriesheim (DE)

Correspondence Address: FITCH EVEN TABIN AND FLANNERY, 120 SOUTH LA SALLE STREET, SUITE 1600, CHICAGO, IL, 60603-3406, US

(73) Assignee: Graffinity Pharmaceuticals AG, Heidelberg (DE)

(21) Appl. No.: 10/564,146

(22) PCT Filed: Jun. 21, 2004
(86) PCT No.: PCT/EP04/06702

§ 371 Date: Feb. 22, 2007

(30) Foreign Application Priority Data
Jul. 11, 2003 (DE) 103 31 517.9

(51) Int. Cl. G01N 21/55

(52) U.S. Cl. 356/445; 427/585; 428/623

(57) ABSTRACT

The invention relates to a sensor arrangement comprising a radiation-conducting substrate, said arrangement having a plurality of sensor fields and separating regions for separating the individual sensor fields from the respectively adjacent sensor fields. Said separating regions are formed by a separating agent layer that causes a reflectivity lower than 0.5 for radiation from the substrate on the interface between the separating agent layer and the substrate, at least in a first region adjacent to the interface between the separating agent layer and the substrate, and an extinction higher than 0.95 at least in a second region located above the first region, on the side opposing the substrate.

The present invention pertains to a sensor arrangement for optical measurement arrangements and to methods of manufacturing said sensor arrangement as well as methods of depositing liquid samples on a sensor arrangement.

One current approach in the search for active substances consists in producing a large number of various chemical compounds using automated synthesis equipment. This large variety of structures is then tested for binding to interaction partners which often constitute biomacromolecules such as protein. An automated method of assaying a large number of samples in this manner is also referred to as high throughput screening.

Due to the biological dispersion of measuring results in binding studies, it is of particular importance that the binding test be carried out under exactly the same conditions for all the compounds. As far as possible, the test should therefore ideally be carried out simultaneously and using the same solution of the interaction partner to be assayed for all the samples so as to exclude ageing effects and temperature drifts as well as different binding times for the compounds. Due to the complexity of the methods for purifying biomacromolecules, the quantities required for the test should be kept to a minimum.

Beside measurement parallelisation, the miniaturisation of the measuring or sensor fields in the measuring apparatus is of great importance in order to increase the number of sensor fields as well as the density thereof and thus to attain not only comparable results by parallelising the measurement but also a dramatic increase in the number of measurements per time unit.

The methods used in this connection are often based on optical measuring methods. Beside optical methods, which require that the sample be irradiated, optical reflection methods are also known, in which the sample is assayed on the basis of the radiation that has been, at least in part, reflected at an interface.

Interferometry is one such optical reflection method, with reflectometric interference spectroscopy (RIfS) being specifically used for binding assays.

Another particularly effective method of carrying out binding tests is surface plasmon resonance spectroscopy (abbreviated as SPR from the English: surface plasmon resonance). In SPR, an interaction partner (e.g. ligand) is immobilised on a metal surface and its binding to a different interaction partner (e.g. receptor) is demonstrated. For this purpose, an optical slide (mostly a prism) is coated with gold and the drop in the intensity of the light internally reflected in the prism is detected as a function of the set angle or as a function of the wavelength (Kretschmann configuration). What is ultimately demonstrated is a variation in the refractive index of the medium on the side opposite the gold film, which occurs when molecules bind to the surface.

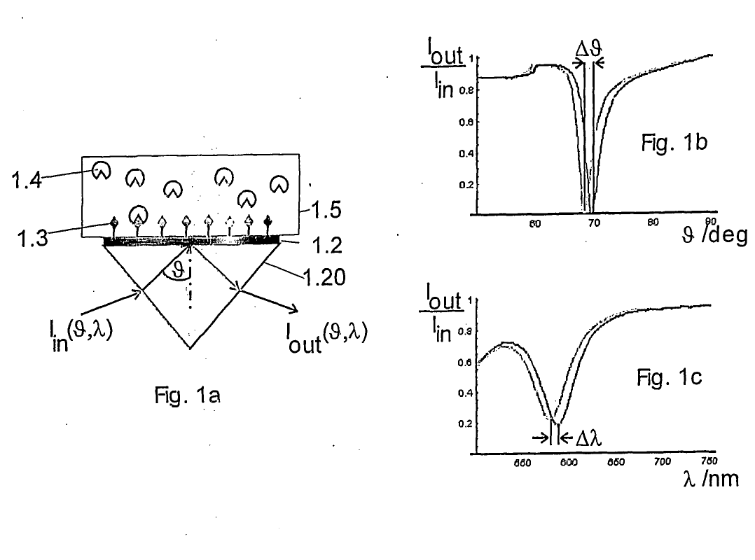

FIG. 1a is a schematic representation of what is known as Kretschmann geometry, which is frequently used to measure the SPR effect. In this case, a thin gold film 1.2 disposed on a prism 1.20 is brought in wetting contact with the solution 1.5 to be assayed. The ligands immobilised on the gold film are identified with reference numeral 1.3, while the potential interaction partners in the solution are identified with reference numeral 1.4. What is usually measured is the intensity of the light internally reflected at the interfaces glass/gold/liquid, either as a function of the angle of incidence Θ or as a function of the wavelength λ. Under a suitable resonance condition, the intensity of the reflected light will be strongly reduced. The energy of the light is then converted into electron charge density waves (plasmons) along the interface gold/liquid. The resonance condition is approximately as follows (from chapter 4, “Surface Plasmon Resonance” in G. Ramsay, Commercial Biosensors, John Wiley & Sons (1998)):

$$\frac{2 π}{λ} {n}_{prism} sin ϑ \approx \frac{2 π}{λ} \sqrt{\frac{{n}_{metal}^{2} ( λ ) {n}_{ sample}^{2}}{{n}_{metal}^{2} ( λ ) + {n}_{ sample}^{2}}}$$

wherein nₚᵣᵢₛₘ is the refractive index of the prism, nₘₑₜₐₗ is the complex refractive index of the metal layer and nₛₐₘₚₗₑ that of the sample. Θ and λ are the angle of incidence and wavelength of the irradiated light. The wavelength spectra (FIG. 1b) and the angle spectra (FIG. 1c) respectively show a decrease of intensity in the wavelength range and in the angle range in which the above resonance condition is fulfilled. When the refractive index in the solution nₛₐₘₚₗₑ changes, the resonance condition is modified, thus displacing the resonance curves. In the case of minor variations in the refractive index, the value of the displacement is linear to said variation (a calibration can be performed for larger variations, if necessary). Considering that the reflected light penetrates only a few 100 nm into the liquid, the refractive index variation is measured locally in this region. When the target molecules (e.g. proteins) 1.4 present in the solution bind to suitable interaction partners 1.3 which are immobilised on the surface (i.e. an association-dissociation equilibrium is created), the concentration of the target molecule rises locally at the surface and can then be proven as a refractive index variation.

So as to enable the aimed parallelisation and miniaturisation initially mentioned herein, it is desirable that numerous sensor fields be provided on a substrate.

The individual sensor fields should be separated from one another by light-absorbing regions; said separation can be implement e.g. by absorbing lacquers. The purpose of such light-absorbing regions is to produce a contrast that allows image areas to be allocated to sensor fields when the sensor arrangement is reproduced on a position-sensitive detector.

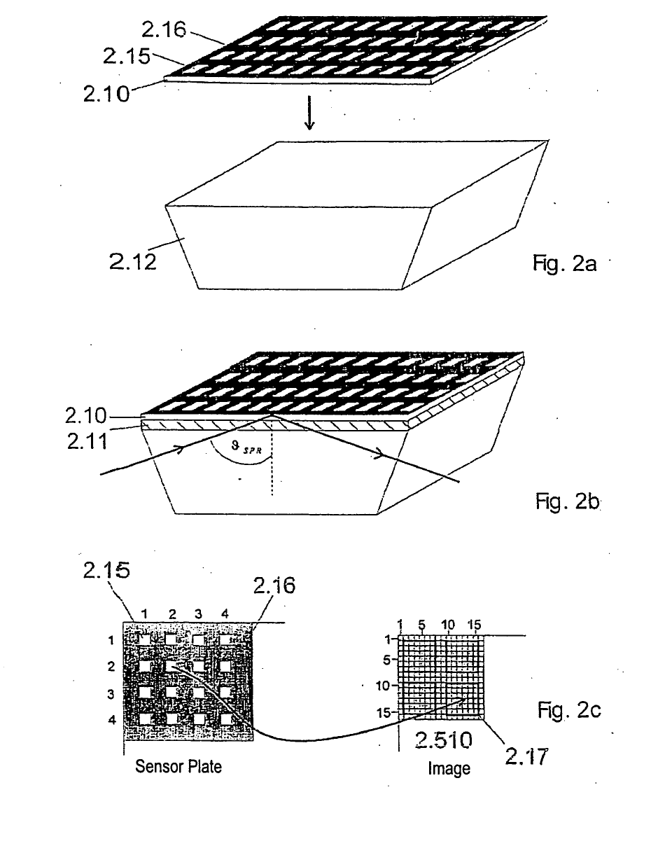

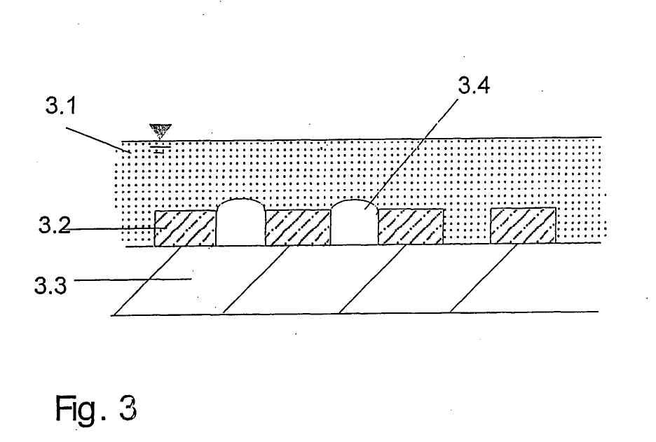

Such a substrate 2.10 including sensor fields 2.15 and separating means 2.16 is shown in FIG. 2a. This substrate 2.10 is placed on a prism 2.12 by means of an index matching layer 2.11 (e.g. index matching oil). Via said prism 2.12, it is then possible for radiation capable of striking the sensor fields at a suitable angle range to be coupled in as well as for the reflected radiation to be coupled out again (see FIG. 2b). An optical imaging means (not shown) is disposed downstream of the prism 2.12, with said means directing the reflected radiation to a suitable sensor, e.g. a CCD chip. This is represented schematically in FIG. 2c which shows the allocation of the sensor areas 2.15 to the corresponding pixel regions 2.17 on the CCD sensor 2.510.

WO-A-01/63256 discloses such light-absorbing regions in the form of separating means, with absorbing metal or semiconductor layers, or polymers (e.g. photoresist, silicon) being proposed as suitable materials. These separating means should have a thickness between 10 and 5,000 μm.

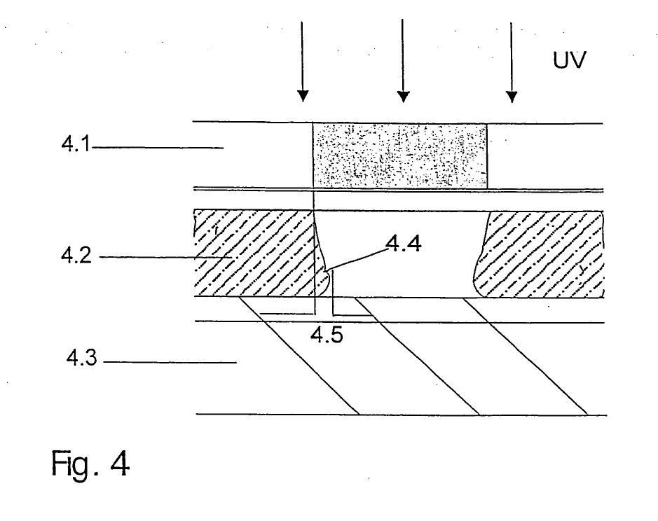

When increasing the density of the sensor fields, the surface area of the sensor fields is reduced. The following difficulties were observed when attempting to manufacture compact sensor arrangements using photoresist as a separating agent:
The geometric thickness of the lacquer of some μm produces an edge, with gas bubbles being formed on these edges due to the surface tension of the measuring solution. It is apparent that the aspect ratio layer thickness : diameter has an impact thereon since this effect was not observed in the case of larger fields. The addition of wetting enhancers does not provide a reliable solution either. This is shown in FIG. 3, which is a schematic representation of a cross-section through a sensor arrangement, with 3.3 designating the substrate, 3.2 the photoresist layer used as a separating agent, and 3.1 the measuring solution. The sensor fields are disposed in the free regions between the separating means 3.2. There are gas bubbles 3.4 trapped in some of these regions.
When structuring thick layers (thick meaning 10 μm or slightly more), the edge quality is reduced, i.e. the lacquer is often infiltrated, as shown in FIG. 4. In this Figure, 4.1 designates a photomask for structuring a lacquer 4.2 on a substrate 4.3. The infiltrated regions 4.5, which are located under protuberances 4.4, will not be coated with metal during the later vapour deposition of gold and will lead to total reflectance during the subsequent measurement in the SPR measuring equipment, thus deteriorating the SPR signal.

The use of thinner lacquer layers is not possible since this does not produce sufficient contrast between the sensor fields and the separating regions.

Thus, it is the object of the present invention to provide a functional sensor arrangement of the above type, whose sensor fields are delimited by separating means which may be formed with a significantly lower thickness than that of the separating means known from the prior art, preferably having a thickness of less than 1 μm.

This object is solved by the features of patent claim 1 and the subject matters of the independent claims. Advantageous embodiments are the subject matter of the dependent claims.

According to the invention, a separating agent layer which constitutes the separating regions is formed to cause a reflectivity lower than 0.5 at the interface between the separating agent layer and the substrate, at least in a first region adjacent to the interface between the separating agent layer and the substrate. The separating agent layer is further formed to cause an extinction higher than 0.95, at least in a second region located above the first region on the side opposing the substrate.

The two regions can be part of a unified layer or can be formed by two different, superposed layers.

It is by creating a reflectivity lower than 0.5 at the interface and by achieving, at the same time, an extinction higher than 0.95 in the region thereabove, that sufficient contrast between the separating means and the sensor regions can be produced, even with a small layer thickness. The design of the separating agent layer according to the invention, including said two regions, particularly enables the thickness of the separating agent layer to be reduced such as to prevent the above-mentioned problems. This in turn makes it possible to provide sensor arrangements having a large density of sensor fields, e.g. larger than 250 fields per cm².

Those sensor arrangements with a high sensor field density make it possible to carry out efficient high throughput measurements with sensor plates comprising, for example, about 10,000 fields, the total surface area of which is less than 20 cm², as opposed to conventional sensor plates which, while having the same number of fields, are larger by one or two orders of magnitude. As a result of the large surface area dimensions of conventional sensor plates, the corresponding optical measurement arrangements (i.e. lens systems) are very large, i.e. lenses with diameters larger than 15 cm as well as accordingly large lens distances of up to several metres are required. This renders conventional measurement arrangements very expensive since the optical components have to be custom-built, and very impractical given that these arrangements take up entire rooms.

In contrast thereto, those sensor arrangements having a high sensor field density allow the use of a compact optical measurement arrangement which may be built of commercially available optical components and which may easily fit on a laboratory bench.

A further advantage of a high field density is the reduced need for a target molecule present in the solution, such as protein. It is precisely the amount of available protein that often constitute a critical value.

The present invention will now be described on the basis of preferred embodiments, with reference being made to the Figures, in which:

FIG. 1 is a schematic representation of an SPR measurement arrangement and characteristic resonance curves;

FIG. 2 shows a sensor plate comprising sensor fields and separating regions;

FIG. 3 illustrates the problems of gas bubble formation in conventional sensor arrangements;

FIG. 4 illustrates the problems of undercut in conventional sensor arrangements;

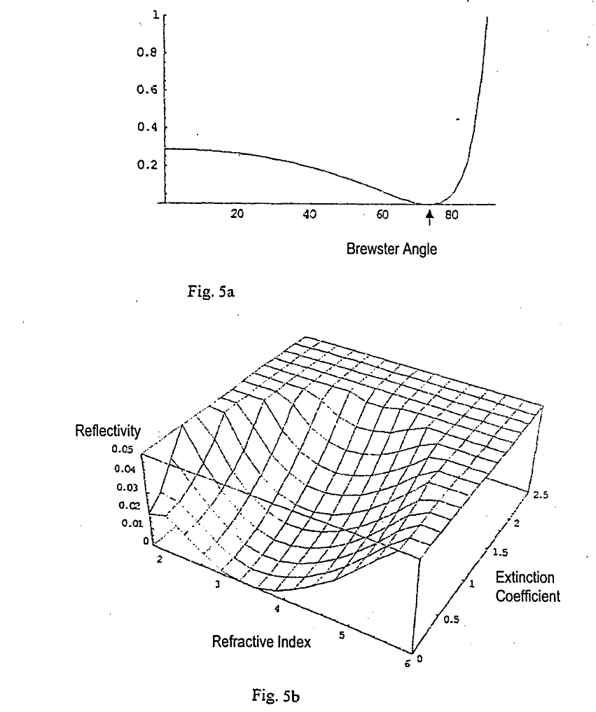

FIG. 5 is a graphical illustration of the connection between refractive index, extinction coefficient and reflectivity;

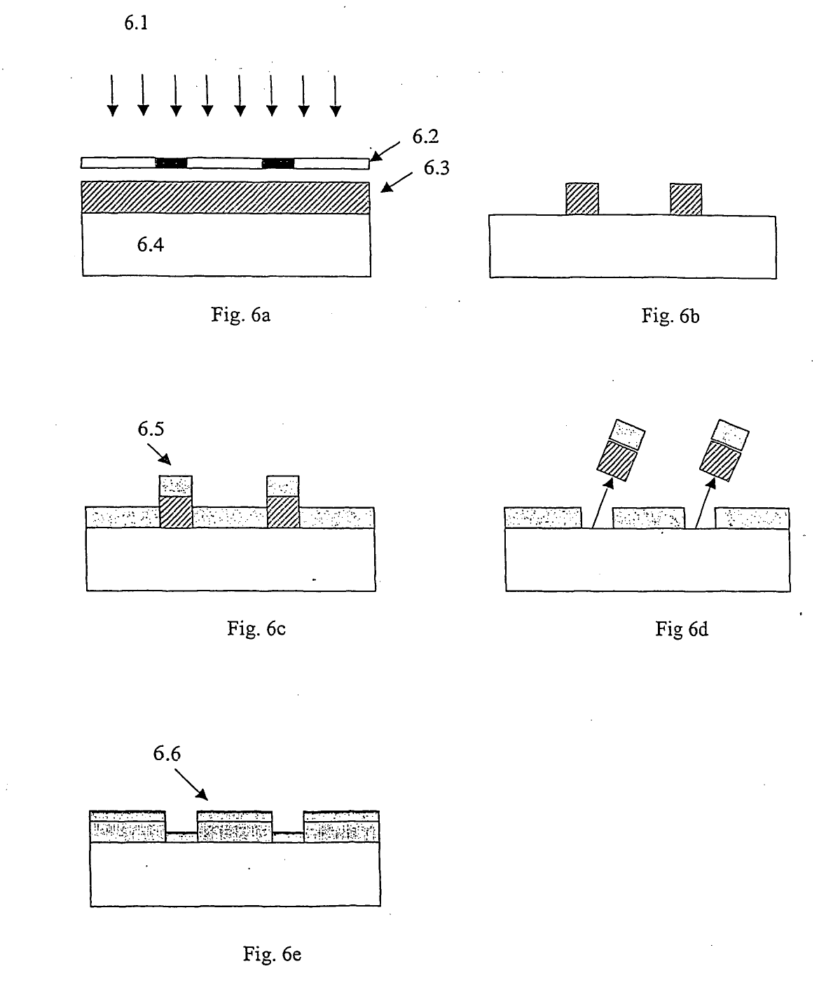

FIG. 6 is a schematic representation of a method of manufacturing a sensor arrangement;

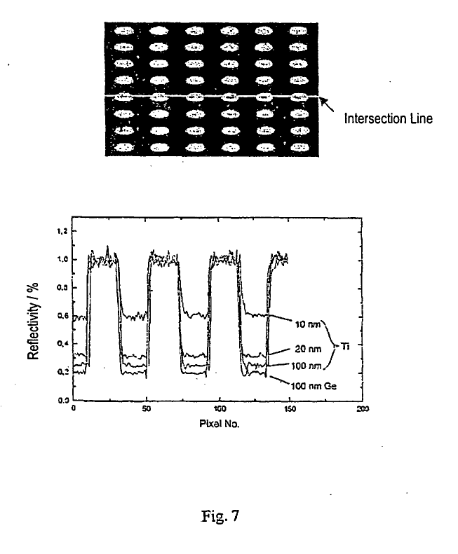

FIG. 7 shows reflectivity measurements on sensor arrangements which are in accordance with the invention;

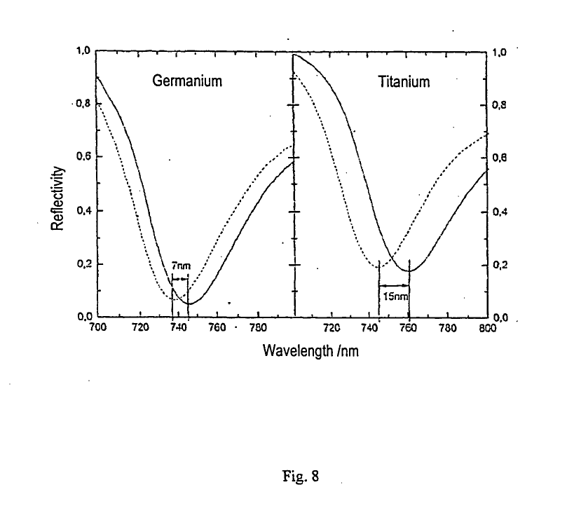

FIG. 8 shows SPR measurements on sensor arrangements which are in accordance with the invention;

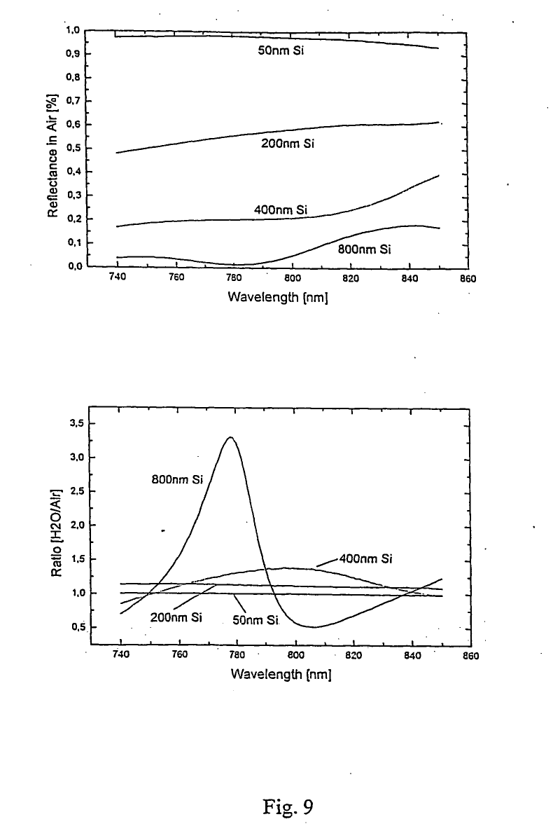

FIG. 9 shows reflectivity spectra for silicon layers;

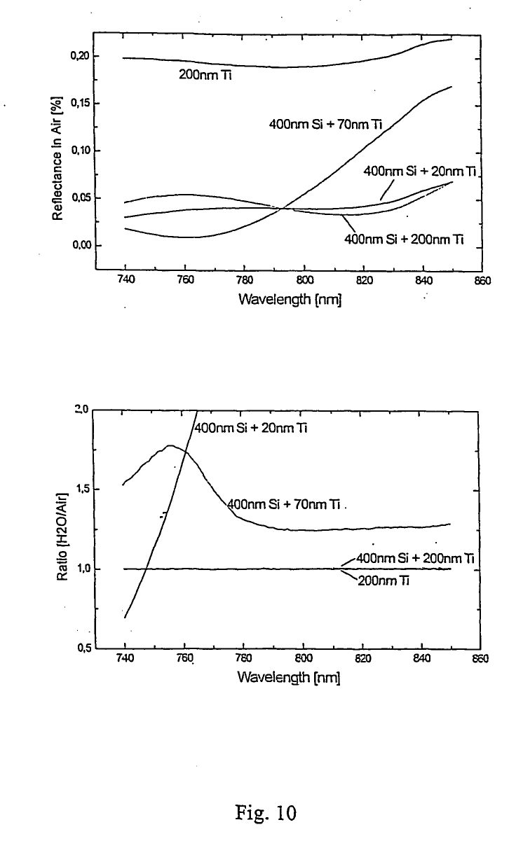

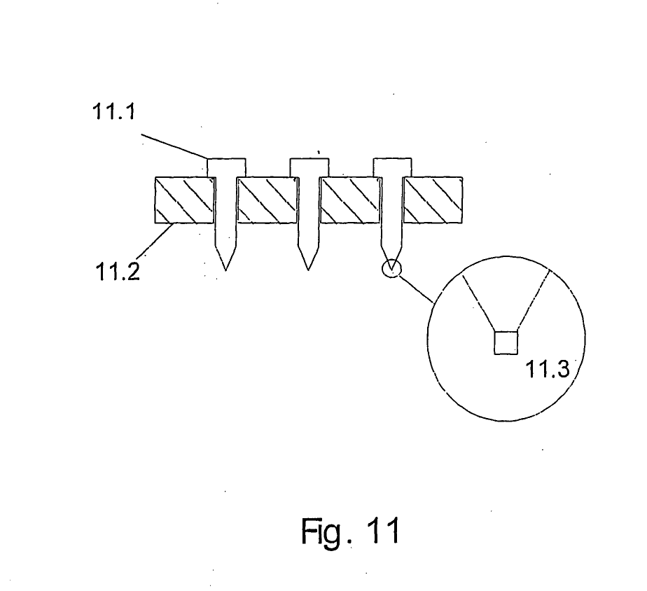

FIG. 10 shows reflectivity spectra for titanium and two-layer systems of titanium and silicon;

FIG. 11 is a schematic representation of the cross-section through an array of transfer pins which are provided for depositing liquid samples on the sensor fields of a sensor arrangement;

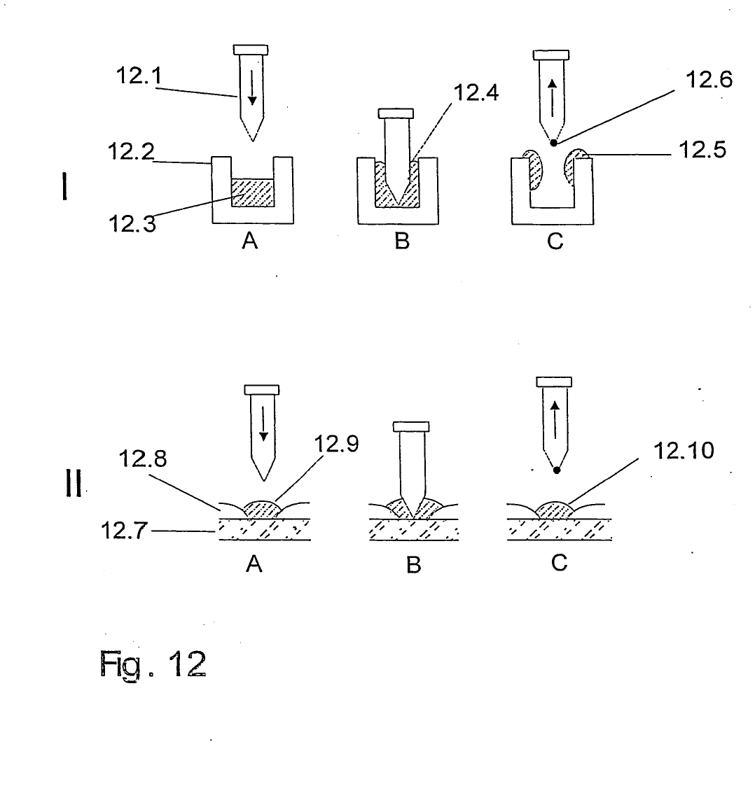

FIG. 12 is a schematic representation of the transfer of liquid samples to sensor fields;

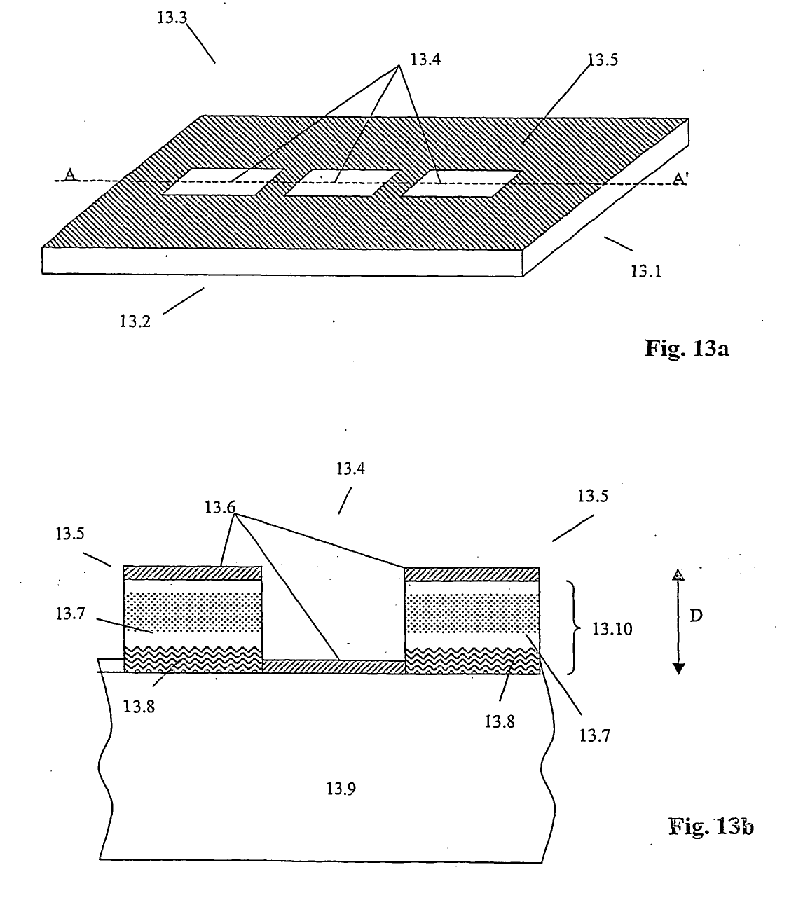

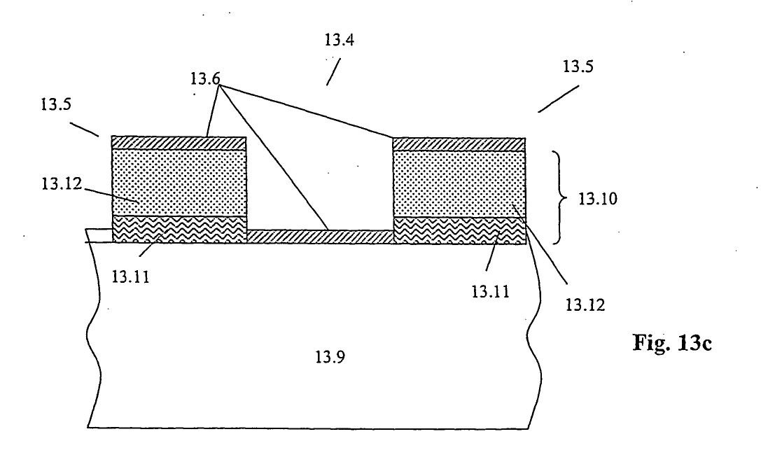

FIG. 13a shows a perspective view of a sensor arrangement; and

FIGS. 13b and 13c are schematic cross-sectional views of embodiments of the separating agent layer as according to the present invention.

One embodiment of the present invention will now be described on the basis of FIG. 13. It should be mentioned that this embodiment is described in connection with SPR, which is also a preferred application of the invention. However, this invention is not limited to SPR since the sensor arrangements as according to the invention can be used for all measuring systems in which reflectance measurements are carried out on sensor fields.

The sensor arrangement 13.1 comprises a radiation-conducting substrate 13.9 having a first and a second surface. The first surface 13.2 is a radiation passage area through which radiation of a given wavelength range can be coupled into said substrate 13.9 as well as coupled out of said substrate 13.9. This radiation passage area is typically connected to a prism by means of an index matching layer, as shown in FIG. 2, provided that the prism itself does not constitute the substrate. Radiation is guided to the substrate 13.9 and therefrom via the prism.

In the example of FIG. 13, the sensor arrangement is formed as a flat plate, which is preferred but not essential.

In the case of SPR measurements on gold surfaces, the wavelength range of interest can range from the long-wave range of the visible spectrum up to the near infrared, for example, between 500 and 1,500 nm.

A plurality of sensor fields 13.4 is provided on the second surface 13.3, with said sensor fields being designed to reflect radiation of the given wavelength range from the substrate 13.9, which is incident at a predetermined angle range. These sensor fields are regions coated, for example, with gold (see 13.6 in FIG. 13b) or another SPR-suitable material, in which surface plasmons can be excited. For SPR measurements on gold surfaces, the angle range of interest can be between 55 and 80 degrees.

In the case of RIfS, a chemically modified glass surface is used as a sensor field, and the angle for reflectance is clearly smaller than in SPR.

The second surface 13.3 further comprises separating regions 13.5 for separating the individual sensor fields 13.4 from the respectively adjacent sensor fields 13.4. The separating regions 13.5 are designed to absorb radiation of the given wavelength range from the substrate 13.9, which is incident at a predetermined angle range, so as to produce a contrast between the sensor fields 13.4 and the separating regions 13.5 in the radiation reflected at the sensor fields 13.4.

The separating regions 13.5 are formed by a separating agent layer 13.10 (see FIG. 13b) on the second surface 13.3 of the substrate 13.9. The separating agent layer 13.10 causes a reflectivity lower than 0.5, preferably lower than 0.25, for radiation of the given wavelength range from the substrate, which is incident at a predetermined angle range, at the interface between the separating agent layer 13.10 and the substrate 13.9, at least in a first region 13.8 adjacent to the interface between the separating agent layer 13.10 and the substrate 13.9.

At the same time, the separating agent layer 13.10 causes an extinction higher than 0.95 for radiation of the given wavelength range, at least in a second region 13.7 located above the first region 13.8 on the side opposing the substrate 13.9.

As a result of the reflectivity being lower than 0.5, a maximum of 50% of the incident radiation is reflected at the separating regions, while the reflectivity at the sensor fields (outside the SPR resonance) is approximately 1. The extinction at least in the second region, and preferably in the entire layer 13.10, prevents a considerable amount of radiation from being transported through the layer 13.10, reflected at the top side of the layer and then refracted again into the substrate 13.9 after the renewed passage through the layer. All in all, this ensures that a good contrast is created between the separating regions and the sensor fields.

The first and the second region 13.7, 13.8 may belong to one unified layer 13.10. In such case, the layer 13.10 will consist of a material that can attain both the required reflectivity and the required extinction. The reflectivity is largely dependent on the refractive indices of the materials adjoining at the interface, and the extinction on the extinction coefficient of the material of the separating agent layer. However, it should be noted that the extinction coefficient is the imaginary part of the complex refractive index of the separating agent material, thus also having an influence on the reflectivity.

First of all, the adjustment of reflectance will be considered: When light is reflected at the interface between two media of different refractive indices (n₀: refractive index on the incident side, i.e. the substrate 13.9, n₁: refractive index of the medium in which the light is refracted, i.e. the separating agent layer 13.10), there exists for p-polarised light what is known as the Brewster angle, at which the light penetrates the medium completely, i.e. reflection disappears (see FIG. 5a).

The Brewster angle can be calculated from the values of the refractive indices using the following formula: tan(θ_{B})=n₁/n₀.

P-polarised light is used for SPR measurements. When considering the SPR angle θ_{SPR} as given by the remaining experimental conditions, and specifying the refractive index of the substrate n₀, the refractive index of the separating agent layer n₁ is to be ideally selected as
n₁=n₀ tan(θ_{SPR})

In this case, all the light will penetrate the separating agent layer.

However, the physics at the interface between two media, of which one has absorptive properties, i.e. a non-negligible extinction coefficient, is not correctly described in the above manner.

For a correct description of the reflection of p-polarised light, the Fresnel formula has to be used. In accordance therewith, the amplitude relationship of reflected light and incident light is:

$$r = \frac{tan ( {θ}_{0} - {θ}_{1} )}{tan ( {θ}_{0} + {θ}_{1} )}$$

and the reflection coefficient is obtained therefrom:
R=rr*
wherein θ₀ is the angle of incidence and θ₁ the angle of the refracted beam. The angle of incidence is the SPR angle and the angle of the refracted beam is obtained from the law of refraction.
n₀ sin(θ₀)=n₁ sin(θ₁)

In the case of a material with extinction (e.g. metals), n₁ will be complex, i.e.
n₁=n₁ᵣ−i
wherein n₁ᵣ is the real refractive index and [symbol] the extinction coefficient. It follows from the law of refraction that the calculated angle θ₁ also has to be complex. FIG. 5b is obtained when plotting the reflection coefficient R, e.g. with a hard angle of incidence θ₀=θ_{SPR}˜66° and a given refractive index of the substrate (here: n₁˜1.5) against the real part and the imaginary part of the refractive index.

What has been plotted here is the reflection coefficient R (from 0 to 5%) against the real part of the refractive index (from 2 to 6) and the extinction coefficient [symbol] (from 0 to 2.5). It can be seen that, in order to reduce the reflectivity, the real part of the refractive index should be between 2 and 6 and the extinction coefficient should be lower than 2. Thus, it can be seen that the extinction coefficient must not be too high since this increases the extinction but also the reflectivity.

A lower limit for the extinction coefficient [symbol] is obtained from the consideration that a layer thickness of 1 μm should be sufficient to absorb 95% of the light, which is desirable in order to ensure that the reflection spectra of the sensor fields are not significantly impaired by those of the separating means when carrying out the binding measurement. The preferred lower limit will then be 0.1.

For reasons of easier manufacturing, it is desirable that the unified material of the layer 13.10 be a vapour-depositable material. This is preferably titanium or germanium, which exhibit the desired reflection and extinction for the desired polarisation direction, for substrate materials having a refractive index between 1.3 and 1.8, an angle range between 55° and 80°, as well as a wavelength range between 500 and 900 nm, when selecting a layer thickness of D=200 nm for the layer 13.10.

In connection with titanium, it should be noted that this material is known in the field of SPR technology as a bonding material between gold and glass substrates. However, it is only applied in very thin layers of only a few nm and it is used precisely for the reason that it does not cause a noticeable attenuation of the radiation, the entirety of which is expected to reach the gold layer, if possible, so as to excite plasmons therein. This is in complete opposition to the principle of the present invention, i.e. to use a material for the separating agent layer, which causes a strong attenuation.

As an alternative to the implementation of the two regions in a single-layer structure, the invention may also be implemented by a multi-layer structure. In this case, the first region 13.8 forms part of a first layer 13.11 comprised by the separating agent layer 13.10 (see FIG. 13c) and the second region 13.7 forms part of a second layer 13.12 which is comprised by the separating agent layer 13.10 and is different from the first layer 13.11. In the embodiment shown in FIG. 13c, the layer 13.11 serves to bring the reflectivity below 0.5, and the layer 13.12 to effect the desired extinction. It should be noted that there may be further layers disposed between the layers 13.11 and 13.12; however, for the sake of simplicity, this is not shown here.

The first layer 13.11 preferably comprises silicon or germanium, both of which exhibit a low reflectivity when the refractive index of the substrate is between 1.2 and 1.8. The second layer 13.2 preferably comprises germanium or a metal, preferably again titanium or chromium.

The first and second regions 13.8, 13.7, which may respectively have the same thickness as the first and second layers 13.11, 13.12 or a lower thickness, each have a preferred maximum thickness of 1 μm. As a result, the separating agent layer 13.10 can have a thickness D of 2 μm or more. The separating agent layer 13.10 should preferably have a maximum thickness D of 1 μm.

It is further preferred that the thickness of the second region 13.7 be higher than 70 nm, and preferably higher than 200 nm. The first region 13.8 should have a thickness of more than 10 nm, preferably more than 20 nm. The first and the second region together should have a thickness of at least 80 nm, and preferably of no less than 100 nm, with a minimum of 200 nm being particularly preferred.

The present invention allows to manufacture separating agent layers having a thickness D of not more than 2 μm, and in particular of less than 1 μm. This enables, in turn, a reduction in the dimensions of the sensor fields without the problems of bubble formation or undercut mentioned above. In this regard, the form of the sensor fields may be freely selected, e.g. rectangular (as suggested in FIG. 13) or circular (as shown in FIG. 7). The sensor fields may have a diameter or a diagonal of 100 μm or less. Each of the sensor fields has a preferred surface area of less than or equal to 6.2×10⁻⁴ cm².

The surface density of the sensor fields can be increased considerably with respect to the prior art, being preferably of 250 fields per cm² or more. Due to the possibility of providing small sensor field surfaces and high surface densities, a sensor arrangement designed according to the invention, which comprises about 10,000 sensor fields, can have a total surface area of less than or equal to 20 cm².

This makes it possible, in turn, to provide a measurement arrangement which is strongly reduced with respect to the size of current measurement arrangements, and which may in addition be equipped with commercially available optical elements, i.e. which do not need to be custom-built. Such an optical measurement arrangement can have a surface area of 1 to 2 m² and a height of approximately 1 m, so that it may easily fit on a laboratory bench or the like. The basic measurement arrangement may in such case be configured as shown in FIG. 2, i.e. beside the sensor arrangement 2.10, an optical means is provided, e.g. the index matching layer 2.11 and the prism 2.12, for coupling radiation of the wavelength range of interest into the substrate of the sensor arrangement via the first surface, at an angle within the angle range of interest, and for coupling out the radiation reflected by the sensor fields. A radiation source (not shown) is to be further provided to supply radiation of the given wavelength range to the optical means, as well as a detector (see FIG. 2c) which is arranged to detect the radiation coupled out of the optical means and reflected by the sensor fields.

The sensor arrangements as according to the present invention may be manufactured in any suitable or desired manner. The separating agent layer is preferably applied by vapour deposition since this enables a high-quality production of thin layers of less than 1 μm.

FIG. 6 is a schematic representation of a manufacturing method. First of all, a structurable lacquer layer 6.3 is applied to the substrate 6.4. The lacquer layer 6.3 is then structured by exposure through a suitable mask 6.2 so as to define the free regions (FIG. 6a). The lacquer is then removed so that lacquer remains only in the area of the free regions, as shown in FIG. 6b. One or more first materials 6.5 are then vapour-deposited to form the first region (13.8 in FIG. 13) and one or more second materials are thereupon vapour-deposited to form the second region (13.7 in FIG. 13), see FIG. 6c. FIG. 6d shows a lift-off process to lift off the coated lacquer present in the free regions so as to expose the substrate at the free regions. In a final step, an SPR-suitable layer 6.6, e.g. of gold, is deposited, at least in the free regions, to form the sensor fields. The separating agent layer is preferably also provided with the SPR-compatible layer since this simplifies the manufacturing process while creating, at the same time, a protection for the separating agent layer.

As an alternative to the above method, the steps shown in FIGS. 6a and 6b may be substituted by depositing a structured lacquer layer using a screen printing technique, with the subsequent steps 6c-6e remaining the same.

Instead of the methods described hitherto, an etching process can also be used for the structuring. This encompasses a homogeneous vapour deposition of the separating agent material over the entire substrate. The later separating regions are then protected by structurable lacquer. This can be carried out, for example, by means of lithography or screen printing. The sensor fields are subsequently exposed by selectively etching and removing the protective lacquer.

FIG. 7 shows reflectivity measurements for an embodiment of the invention in which the separating agent layer was formed by a unified layer of titanium or germanium. The top half shows a reproduction of the image on the detector (see FIG. 2c), with the light fields corresponding to the sensor fields and the black region corresponding to the separating agent layer. The sensor fields covered with gold had a diameter of 110 μm. The actual circular fields appear oval in the illustration, which is due to a tilt of the optical imaging system. The graph in the bottom half of FIG. 7 shows the reflectivity along the indicated intersecting line, outside SPR resonance. What is plotted here are measurements for three different titanium layer thicknesses: 10 nm, 20 nm and 100 nm, as well as for germanium in a thickness of 100 nm. It becomes apparent that a separating agent layer of 100 nm thickness causes the lowest reflectivity (approx. 20%), thus constituting a preferred layer thickness, and that germanium provides a slightly better contrast than titanium.

FIG. 8 shows the result of specific SPR measurements on the embodiments of the invention described in connection with FIG. 7. What is shown are the results of binding experiments with biosensors in which biotin was immobilised on the sensor fields. The dashed resonance curves were generated by wetting with a reference buffer. The continuous curves were recorded after incubation with avidin, a known biotin receptor. The displacement of the resonance curves increases linearly with the amount of bound avidin. Surprisingly, the signal measured in the sensors which had an absorbing layer of titanium was clearly higher than that measured in the sensors comprising germanium, although there was a better contrast in the case of germanium (cf. FIG. 7). This is probably due to a higher biocompatibility of titanium.

FIG. 9 shows measurements of reflection intensity on sensor arrangements in which the separating agent layer consisted of silicon. The top graph shows results with respect to air, i.e. there was air on the surface of the sensor arrangement. Sensors were produced with a separating agent layer of 50, 200, 400 and 800 nm thickness and the reflection spectra thereof was measured in the SPR equipment between 750 and 850 nm. Measurements were also carried out with respect to water, i.e. there was water on the surface of the sensor arrangement, and the bottom graph shows the relationship between the measured reflection intensities. It can be seen that in the case of 800 nm Si, reflectance with respect to air falls below 10%, but the relationship between reflectance in water and reflectance in air varies significantly. This means that part of the light penetrates through the entire Si layer and is reflected back therefrom due to the low extinction coefficient of Si. Thus, Si does not satisfy the requirements of the present invention for separating agent layers of a thickness lower than 1 μm.

However, according to the invention, Si may be used in a two-layer structure, with Si being used as the first layer 13.11 (see FIG. 13), due to its low reflectivity, and a material with low transmittance, such as titanium, being used as the second layer 13.12. This means that Si and titanium are combined to attain both a low reflectivity (Si) and a low transmittance (Ti). FIG. 10 shows measurements of reflection intensity for different Si/Ti combinations, with the top graph showing the reflection intensity with respect to air and the bottom graph showing the relationship between the reflection intensities with respect to water and air, similarly to FIG. 9.

With an easily implementable layer thickness for Si of 400 nm, different thicknesses of Ti (20, 70, 200 nm) were additionally vapour deposited. For the purpose of comparison, Ti is also plotted on its own, with a reflectivity of about 20% being thus achieved. As can be seen, when Si=400 nm and Ti=200 nm are combined, the reflectance falls below 10% and, at the same time, the relationship between reflectance in water and reflectance in air remains unchanged.

It is therefore preferred to select the combination Si=400 nm and Ti=200 nm for a two-layer structure so as to obtain an easily implementable layer system, which is, in addition, particularly biocompatible given the good biocompatibility of Ti.

Surprisingly, the relationship between the reflectivity of the separating agent layer with respect to air and with respect to water proves to be important in thin layers since this relationship is observed as a superposition in the data acquisition of the SPR spectra. When this relationship varies across the wavelength, such as is the case, for example, with 800 nm Si in FIG. 9, a “bump-like” spectral variation is later superposed in the SPR spectrum, thus leading to artefacts when the SPR displacements are analysed.

Beside the bubble formation and the undercut mentioned above, a further difficulty when it comes to miniaturising sensor arrangements is the precise application of the samples to be measured on the sensor fields, which is also referred to as spotting. It is known to deposit small drops by means of steel needles on glass slides in what is known as DNA chips.

However, in the sensor arrangements as according to the invention, where the sensor field dimensions are smaller than 100 μm, the aimed positioning accuracy should be better than 10%, i.e. smaller than 10 μm. This is not possible with the known spotting of DNA chips.

As regards the spotting of DNA chips, it should be further noted that, when spotting chemical microarrays, the plunge needles, e.g. steel needles, need to remain on the sensor field for a few seconds in order for the reagents in the drops to react with the active surface and not to migrate electrostatically, for example. Considering that a total of some 1,000 drops need to be further accommodated in each chip, and the spotting has to be finalised in a finite period, it is desirable to develop a technique of high parallelism in the spotting device. This requires, in turn, that the provider plates from which the drops are taken be accommodated in a higher density than that of the known 384-well plates (grid 4.5 mm) as otherwise only 24 steel needles can be used for a chip size of 27×18 mm.

So as to attain the desired positioning accuracy, narrow tolerances were selected in the production of the needle and the needle guide. FIG. 11 shows a schematic representation of such needles 11.1, which are held in a carrier 11.2 having bores for receiving said needles. The needles are manufactured, for example, by machining and grinding and the tips 11.3 of the needles are reduced to a diameter of 100 μm. In order to prevent the needle from bending during rotation, a hard material (wolfram carbide) generally used for manufacturing tools was selected. The needle guide 11.2 was manufactured from aluminium with the required precision.

So as to attain a high density of the cavities or wells in the provider plates, an initial attempt was made to use 1536-well microtiter plates. As a result, the needles 12.1 (see FIG. 12 I) formed, together with the wall 12.2 of the cavity, a capillary gap 12.4 which leads to the fact that, after some immersion processes, the liquid 12.3 is no longer on the floor of the cavity but it is adhered to the wall of the cavity in drop form 12.5 (FIG. 12 IC).

A possible solution is to design the needle to be thinner at the shaft so as to increase the capillary gap, thus reducing the transfer of liquid from the floor of the cavity to the wall. However, due to the desired positioning accuracy this is not possible since a thinner shaft diameter will lead to a stronger bending.

So as to deposit liquid samples 12.3 on a sensor arrangement (13.1, see FIG. 13) which comprises a plurality of sensor fields arranged in a grid that lies in a plane, it is proposed to deposit the liquid drops 12.10 (see FIG. 12 II) on an array of liquid receiving regions 12.9 lying in a plane. This is a form of reformatting. Each liquid receiving region 12.9 is surrounded by a liquid repelling region 12.8 consisting of a material that repels the liquid drops, so that the liquid samples are kept in the liquid receiving regions 12.9 in the form of drops of variable diameter. The liquid receiving regions 12.9 are provided in a grid which is compatible with the grid of the sensor fields.

For this purpose, the liquid may be taken from the 384-well microtiter plates using, for example, relatively thick needles, with the capillary effect being irrelevant in these large cavities, and may be deposited on a glass plate having fields framed with Teflon® lacquer. The liquid repels the Teflon border and is kept in drop form, as shown in FIG. 12 IIA.

So as to transfer the drops 12.10, the array of transfer pins 12.1 is immersed into the liquid drops 12.10 on the liquid receiving regions 12.9 to wet the tips 12.6 of the transfer pins. These transfer pins 12.1 are provided in a grid that is compatible with the grid of the sensor fields, e.g. the same grid or a sub-grid. This enables a highly parallel transfer. The wetted transfer pins are then extracted from the liquid drops and moved over the sensor arrangement. Finally, the wetted transfer pins are lowered over the sensor fields so as to bring the liquid at the wetted transfer pins into contact with the sensor fields.

Given that the drops can expand, no problems of capillary forces occur, and given that the liquid is repelled by material 12.8, the pins are entirely wetted without any problems and may in turn be thick enough to ensure the desired positioning accuracy. The liquid repelling regions 12.8 are preferably elevated with respect to the plane of the liquid receiving regions 12.9 by a maximum of 200 μm, preferably by only 100 μm, with only 30 μm being particularly preferred. It is thus preferred that the liquid receiving regions be arranged as flat as possible.

1. A sensor arrangement comprising a radiation-conducting substrate which includes a first and a second surface, wherein the first surface is a radiation passage area through which radiation of a given wavelength range may be coupled into the substrate as well as coupled out of the substrate, and the second surface comprises
a plurality of sensor fields which are designed to reflect radiation of the given wavelength range from the substrate, which is incident at a predetermined angle range, as well as
separating regions for separating the individual sensor fields from the respectively adjacent sensor fields, with said separating regions being designed to absorb radiation of the given wavelength range from the substrate, which is incident at the predetermined angle range, so as to produce a contrast between the sensor fields and the separating regions in the radiation reflected at the sensor fields, and said separating regions being formed by a separating agent layer on the second surface of the substrate, wherein
the separating agent layer causes a reflectivity lower than 0.5 for radiation of the given wavelength range from the substrate, which is incident at the predetermined angle range, at the interface between the separating agent layer and the substrate, at least in a first region adjacent to the interface between the separating agent layer and the substrate,
the separating agent layer causes an extinction higher than 0.95 for radiation of the given wavelength range, at least in a second region located above the first region, on the side opposing the substrate, and
the separating agent layer comprising one or both of titanium and germanium.

2. The sensor arrangement according to claim 1, wherein the first and the second region form part of a unified layer.

3. (canceled)

4. The sensor arrangement according to claim 1, wherein the first region forms part of a first layer comprised by the separating agent layer, and the second region forms part of a second layer which is comprised by the separating agent layer and is different from the first layer.

5. The sensor arrangement according to claim 4, wherein the first layer comprises one or both of silicon and germanium.

6. The sensor arrangement according to claim 4, wherein the second layer comprises an element selected from the group consisting of germanium, metal and mixtures thereof.

7. The sensor arrangement according to claim 1, wherein the first and the second region each have a maximum thickness (D) of 1 μm.

8. The sensor arrangement according to claim 1, wherein the separating agent layer has a maximum thickness (D) of 1 μm.

9. The sensor arrangement according to claim 1, wherein the second region has a thickness (D) of more than 70 nm.

10. The sensor arrangement according to claim 1, wherein the first region has a thickness (D) of more than 10 nm, preferably of more than 20 nm.

11. The sensor arrangement according to claim 1, wherein the first and the second region together have a minimum thickness (D) of 80 nm.

12. The sensor arrangement according to claim 1, wherein there are at least 100 sensor fields arranged on the substrate.

13. The sensor arrangement according to claim 1, wherein each sensor field has a surface area smaller than or equal to 6.2×10⁻⁴ cm².

14. The sensor arrangement according to claim 1, wherein the sensor fields have a surface density larger than or equal to 250 fields per cm².

15. The sensor arrangement according to claim 1, wherein the substrate is formed as a flat plate.

16. The sensor arrangement according to claim 15, wherein the flat plate has a total surface area smaller than or equal to 20 cm².

17. The sensor arrangement according to claim 1, wherein the sensor fields comprise an SPR-suitable layer.

18. An optical measurement arrangement comprising:
a sensor arrangement according to claim 1,
an optical means for coupling radiation of the given wavelength range into the substrate of the sensor arrangement via the first surface, at an angle within the predetermined angle range, and for coupling out the radiation reflected by the sensor fields,
a radiation source for supplying radiation of the given wavelength range to the optical means, and
a detector arranged to detect the radiation coupled out of the optical means and reflected by the sensor fields.

19. A method of manufacturing a sensor arrangement according to claim 1, comprising the step of:
forming a separating agent layer on the substrate such that free regions defining sensor fields are created, with the separating agent layer being applied by vapour deposition.

20. The method according to claim 19, comprising the further step of applying an SPR-suitable layer, at least in the free regions, to form the sensor fields.

21. The method according to claim 19 wherein the step of forming the separating agent layer comprises
applying a structurable lacquer layer on the substrate;
structuring the lacquer layer to define the free regions, and removing the lacquer such that lacquer remains only in the area of the free regions;
vapour-depositing one or more first materials to form the first region and subsequently one or more second materials to form the second region; and
carrying out a lift-off to lift off the coated lacquer present in the free regions so as to expose the substrate at the free regions.

22. The method according to claim 19 wherein the step of forming the separating agent layer comprises
applying a structurable lacquer layer by means of a screen printing technique;
vapour-depositing one or more first materials to form the first region and subsequently one or more second materials to form the second region; and
carrying out a lift-off to lift off the coated lacquer present in the free regions so as to expose the substrate at the free regions.

23. The method according to claim 19, wherein the step of forming the separating agent layer comprises
vapour-depositing the separating agent material homogeneously over the entire substrate;
protecting the later separating regions by means of structurable lacquer; and
exposing the sensor fields by selectively etching and removing the protective lacquer.

24. The method according to one of claims 20, wherein the step of applying an SPR-suitable layer comprises vapour-depositing an SPR-suitable layer, preferably of gold, on the free regions and the separating agent layer.

25. (canceled)

26. (canceled)

27. (canceled)

28. The sensor arrangement according to claim 6, wherein the second layer comprises titanium or chromium.

29. The sensor arrangement according to claim 9, wherein the second region has a thickness (D) of more than 200 nm.

30. The sensor arrangement according to claim 10, wherein the first region has a thickness (D) of more than 20 nm.

31. The sensor arrangement according to claim 11, wherein the first and the second region together have a minimum thickness (D) of no less than 100 nm.

32. The sensor arrangement according to claim 11, wherein the first and the second region together have a minimum thickness (D) of 200 nm.

33. The sensor arrangement according to claim 12, wherein there are at least 1,000 sensor fields arranged on the substrate.
